(19) United States
(12) Patent Application Publication
(10) Pub. No.: US 2019/0257477 A1
(43) Pub. Date: Aug. 22, 2019

(54) A GAS CYLINDER MONITORING SYSTEM

(71) Applicant: LINDE AG, Munchen (DE)

(72) Inventors: Brian JACOBSEN, West Sussex (GB); Rigoberto PEREZ DE ALEJO, Surrey (GB); Mandip THIND, Southall (GB)

(73) Assignee: LINDE AG, Munchen (DE)

(21) Appl. No.: 16/333,839

(22) PCT Filed: Sep. 15, 2017
(86) PCT No.: PCT/EP2017/073339

§ 371 Date: Mar. 15, 2019

(30) Foreign Application Priority Data
Sep. 15, 2016 (GB) 1615749.7

(51) Int. Cl. F17C 13/02; G01F 22/00; G01F 15/06; B65D 47/02

(52) U.S. Cl. CPC F17C 13/028; G01F 22/00; B60Q 1/52; B65D 47/02; G01F 15/06

(57) ABSTRACT

A gas cylinder monitoring system (10) for monitoring the contents of a gas cylinder in an EMS vehicle (50) including a gas cylinder (12) for receiving and distributing gas therein, an individual cylinder monitoring system (14) operable to monitor data associated with the gas cylinder (12) and having a cylinder monitoring transmitter (16) operable to broadcast the data, and at least one receiving station (60,70) having a receiver (18,20) operable to receive the data from the individual cylinder monitoring system (14) and indicate if the contents of the gas cylinder (12) are below a pre-determined threshold and require replacing.

The present invention relates to a gas cylinder monitoring system for monitoring the contents of a gas cylinder in an Emergency Service (EMS) vehicle, in particular to gas cylinders for supplying clinical gasses such as, for example, oxygen, argon, nitrous oxide, xenon, nitric oxide, helium and mixtures thereof to patients, and for supplying industrial gases such as oxygen, nitrogen and argon and mixtures thereof.

EMS vehicles such as ambulances are in operation continuously, attending casualties requiring immediate medical assistance, and then typically transferring those casualties to a medical environment such as a hospital for further treatment. The mere fact that an ambulance has been called to the casualty indicates the medical situation is serious and therefore it is important the ambulance is fully equipped to be able to treat the casualty immediately. Often, the casualty will require the administration of a clinical gas such as oxygen, and for this reason, ambulances have at least one oxygen cylinder connected to a manifold fixed inside the vehicle, to supply different outlets.

During operation of the EMS vehicle, the gas contents in the cylinder reduce, and it is important therefore that the contents are monitored. Whilst the ambulance driver, or any other personnel in the vehicle, can monitor the gas contents, the main focus is necessarily on treating the casualty, and therefore there is a possibility, particularly in highly stressful situations, that the vehicle personnel are not aware of the gas cylinder contents, and the gas cylinder can run out of gas before it is replaced. This needs to be avoided as it can lead to a situation where the ambulance cannot supply oxygen to a patient in an emergency situation.

In addition to monitoring the gas content, the cylinder needs to be replaced when the content reaches a certain threshold, and therefore it is important that a cylinder at or approaching that threshold can be identified and replaced at an appropriate time, typically when the ambulance containing the cylinder returns to a base station such as a hospital where replacement cylinders are available.

Currently, gas cylinder contents are monitored and replaced by a combination of ambulance and hospital personnel. Successful replacement of gas cylinders relies on firstly the ambulance personnel monitoring the cylinder contents, communicating the contents to the hospital personnel at the appropriate time so that it can be replaced when the vehicle returns to the hospital, and then the hospital personnel identifying which cylinder requires replacing, which also requires identification of the vehicle within which the cylinder is located. The physical procedure of replacing the gas cylinder is not straightforward, nor is identification of the ambulance as there can be several ambulances arriving at the hospital at the same time, and therefore it is important the cylinders are identified and replaced as quickly as possible as it will be appreciated that ambulances are in constant demand, and any delay in deployment can have serious consequences.

Improvements in the monitoring of gas cylinder contents in EMS vehicles are therefore desirable.

Thus, according to the present invention there is provided a gas cylinder monitoring system for monitoring the contents of gas cylinder in an EMS vehicle including a gas cylinder for receiving and distributing gas therein, an individual cylinder monitoring system operable to monitor data associated with the gas cylinder and having a cylinder monitoring transmitter operable to broadcast the data, and at least one receiving station having a receiver operable to receive the data from the cylinder monitoring system and indicate if the contents of the gas cylinder are below a pre-determined threshold and the cylinder needs replacing.

Advantageously, the data broadcast by the cylinder monitoring transmitter identifies if the gas cylinder needs replacing, thereby avoiding the situation of empty or near-empty gas cylinders remaining in the vehicle.

Preferably the receiving station includes a vehicle hub located in the EMS vehicle, for example an ambulance, and the vehicle hub includes an audio and/or visual alarm which is activated if the contents of the gas cylinder are below a pre-determined threshold. The visual alarm can be positioned on the dashboard and/or in another prominent position visible to the vehicle personnel. The alarm ensures the vehicle personnel are made aware of low cylinder contents allowing them to initiate a replacement. The alarm can display actual cylinder contents, an indication that cylinder replacement is required, or both.

The receiving station can additionally or alternatively include a base hub located in a base station which is remote from the EMS vehicle. The base station will have replacement gas cylinders on site, and is typically a medical environment such as a hospital, or a gas cylinder storage depot.

In one embodiment, the cylinder monitoring transmitter is operable to broadcast the data associated with the gas cylinder directly to the base hub.

Alternatively, the individual cylinder monitoring transmitter is operable to broadcast the data associated with the gas cylinder to the vehicle hub, and the vehicle hub includes a transmitter to broadcast that data or selections of that data to the base hub. Broadcasting the data directly to the base hub, or via the vehicle hub, ensures personnel located at the base hub are alerted to the low cylinder levels. Broadcasting via the vehicle hub additionally alerts the vehicle personnel to the low cylinder levels. The vehicle hub is likely to be powered directly by the vehicle, as opposed to the cylinder transmitter which is likely to be battery powered, and it is therefore, in terms of energy consumption, advantageous that the vehicle hub is used to transmit the data over the longer range from the EMS vehicle to the remote base station rather than the battery powered cylinder transmitter.

The data can be transmitted wirelessly using suitable technologies such as Wi-Fi or Bluetooth. The system can also be configured such that the base hub only receives data when the cylinder monitoring system is at the base station and therefore within wireless range of the base hub, and further such that the EMS vehicle is prevented from leaving the base station if the alarm indicating a cylinder requires remains active.

Preferably, the individual cylinder monitoring system can also include a motion sensor which is operable to detect movement of the EMS vehicle, and broadcast the data dependent on that movement, for example, if the EMS vehicle stops or starts, which is typically indicative of EMS vehicle activity, and hence potential gas cylinder usage, then the data can be broadcast. The audio and/or visual alarm can also be suppressed if movement is detected by the motion sensor, so as not to distract the driver of the EMS vehicle.

Preferably the individual cylinder monitoring system includes a GPS device to enable tracking of the location of the gas cylinder. The location, in combination with the transmission of data from the EMS vehicle on the cylinder contents gives advanced warning of when cylinders will arrive at the base station for logistical purposes, specifically to ensure replacement cylinders are available in the correct location for when the EMS vehicle returns to the base station.

Preferably the data includes cylinder identification, gas supply time remaining, expiry date, cylinder type, cylinder location, time since filling, and rate of gas usage.

The system can further include a processor which can identify the specific EMS vehicle which is broadcasting data indicating a replacement is required, therefore enabling quick replacement when the EMS vehicle returns to the base station which is important since the physical procedure of replacing the gas cylinder is not straightforward, and identification of the EMS vehicle minimises the replacement time and hence reduces the time before which the vehicle can be deployed again.

Preferably the vehicle hub includes a receiver operable to receive data from the base hub which is advantageous as it enables the sending of data to the EMS vehicle, and hence the vehicle personnel to indicate a gas cylinder might need replacing.

Typical gas cylinder contents includes at least one of medical air, oxygen, helium, heliox, argon, xenon, nitrous oxide, a nitrous oxide/oxygen mixture and nitric oxide,

The invention will now be described by way of example only with reference to the accompany FIGURE in which:

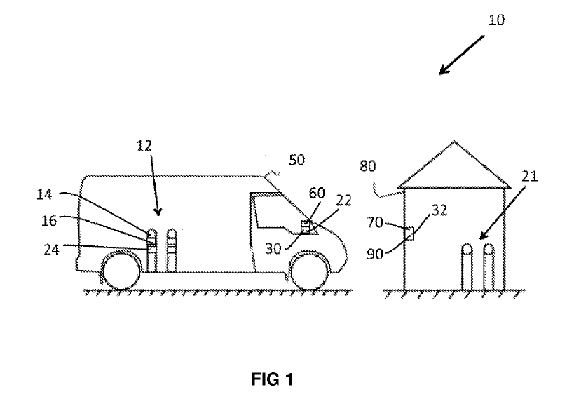

FIG. 1 is a side schematic view of a gas cylinder monitoring system according to the present invention.

In FIG. 1, a gas cylinder monitoring system 10 comprises a gas cylinder 12 located in an EMS vehicle such as an ambulance 50, the gas cylinder 12 having an associated individual cylinder monitoring system 14, a receiving station in the form of a vehicle hub 60 located in the ambulance 50, and a base hub in the form of a hospital hub 70 located at a base station, typically a hospital 80. The individual cylinder monitoring system 14 is integrated with the gas cylinder 12 as opposed to being part of the ambulance 50.

Although only one gas cylinder 12 is shown in FIG. 1, the ambulance includes a manifold (not shown) connected to several gas cylinders. The manifold includes a tube and mask arrangement (not shown) to enable the distribution of gas from the gas cylinder to a patient (not shown).

The hospital hub 80 includes a processor 90 for analysing data sent from the ambulance (the vehicle hub and/or cylinder transmitter) as well as for storing reference data such as pre-determined thresholds at which alarms should be activated. The processor 90 can also include a database which identifies which cylinders are in which ambulance, this being important as it will be appreciated that more than one ambulance can be located at the hospital and therefore being able to associate the empty gas cylinder with the correct ambulance enables quick replacement.

The vehicle 60 and hospital 70 hubs are connected to a permanent power supply, the hospital mains supply in the case of the hospital hub 70, and the ambulance power supply in the case of the vehicle hub 60. Replacement gas cylinders 21 are stored at the hospital 80.

As will be well understood, the ambulance 50 is required to attend casualties requiring immediate medical assistance, and then transfer those casualties to the hospital 80 for further treatment. Whilst during a working day the ambulance 50 does return to the hospital 80, the ambulance 50 is considered to be remote from the hospital in the sense that the ambulance and the hospital are two distinct environments and locations.

The individual cylinder monitoring system 14 monitors data associated with the gas cylinder 12. The individual cylinder monitoring system 14 is powered by a battery (not shown) as it is not practical to connect to a mains power supply as the gas cylinder 12 is frequently moved between the ambulance 50 and the hospital 80.

The individual cylinder monitoring system 14 has a wireless transmitter in the form of a low energy Bluetooth (BLE) transmitter 16 for broadcasting data in the form of an advertisement package (AP) at programmable regular intervals, or in response to an event triggered by the movement or the location of the gas cylinder or some other event as will be described below. The transmitter 16 can also be programmed such that it only broadcasts data if the gas cylinder contents are below a pre-determined threshold.

The data associated with the gas cylinder comprises at least one of cylinder identification, gas supply time remaining, expiry date, cylinder type, cylinder location, time since filling, and rate of gas usage. Example contents of the advertisement package are shown in Table 1. The key data that needs to be transmitted is that which enables identification of the gas cylinder, and the amount of gas remaining.

TABLE 1
Example Advertisement Package

| Offset byte | Advertisement package | New Value (default) |
|---|---|---|
| 0 | Size of the Package | 0x19 |
| 1 | Flag BT standard | 0xFF |
| 2 | Indigo main ID | 0xFF |
| 3 | Indigo product ID | 0xFF |
| 4 | System Status | 0: Not connectable |
| | | 1: Connectable |
| 5 | MCU all OK | Status of port pin (P1, 2) |
| 6 | Reserve Space | 1 |
| 7 | Operating mode | 1: Deep sleep (mode a) |
| | a) Modes not allowed in the | 2: Connected (mode a) |
| | version, so the value must | 3: Standby (sleep) |
| | not be received. | |
| | b) Mode is only allowed but not | 4: Gas delivery (mode b) |
| | connectable | |
| | c) 3x button does not connect. | 5: Fault (mode a) |
| | Advertisement not connectable | 6: Fill plant (mode c) |
| 8 | Tamper state (used since | 0: Not used |
| | last filling) | 1: Used |
| 9-12 | History size | (9—LSB, 12—MSB) |
| 13-16 | PIC firmware version | 13—major version |
| | | 14—minor version |
| | | 15—release number |
| | | 16—build number |
| 17-20 | BLE firmware version | 17—major version |
| | | 18—minor version |
| | | 19—release number |
| | | 20—build number |
| 21-22 | Cylinder pressure (cbar) | (21—LSB, 22—MSB) |
| 23-24 | Cylinder size (ml) | (23—LSB, 24—MSB) |

The vehicle hub 60 includes a vehicle hub wireless transmitter 22 and a vehicle hub receiver 18. The wireless transmitter 22 utilises mobile Wi-Fi to send data over long distances, although other wireless protocols are envisaged.

The base station hub 70 includes a base station hub receiver 20. Both receivers 18,20 are operable to receive data from the cylinder monitoring transmitter 16. The base station hub receiver 20 is also operable to receive data from the vehicle hub transmitter 22. The vehicle hub receiver 18 can also receive data from the base hub 70, for example, an indication that a gas cylinder requires replacing, or other such critical messages.

The cylinder monitoring system 14 includes a GPS device to enable tracking of the location of the gas cylinder 12, which, in combination with the transmission of data from the ambulance on the cylinder contents gives advanced warning of when cylinders will arrive at the hospital for logistical purposes.

The vehicle hub 60 includes an audio and/or visual alarm 30 which is activated when the cylinder monitoring system 14 sends data indicating the gas cylinder contents are below a pre-determined threshold, thereby informing the ambulance personnel the cylinder 12 requires replacing. In addition, or as an alternative, the base hub 80 includes an audio and/or visual alarm 32 which is activated when the cylinder monitoring system 14 sends data indicating the gas cylinder contents are below a pre-determined threshold, thereby informing the hospital personnel the cylinder 12 requires replacing. The alarms 30,32 can also be configured to give an additional signal if the ambulance 50 attempts to leave the hospital with an empty gas cylinder. Another option, for example if all the gas cylinders in the ambulance are empty, is that the signal cooperates with the ambulance 50 to prevent it from leaving until at least one of the empty gas cylinders 12 is replaced. It will be appreciated however that an override function may be required in the event the ambulance is required to leave the hospital without replacing empty cylinders, for example if the ambulance is not attending a casualty requiring a supply of oxygen.

A motion sensor 24 can be associated with the cylinder monitoring system 14 to detect if the ambulance is moving or stationary. The monitoring system 14 can be configured broadcast the data dependent on that movement. In one embodiment, data is broadcast when the ambulance stops, which may coincide with returning to the hospital and an opportunity to replace the gas cylinder if it is empty. Alternatively, data can be broadcast when movement starts or stops as that can indicate the ambulance is active, and hence potential gas cylinder usage.

The alarm 30 in the ambulance 50 can also be suppressed if movement is detected by the motion sensor so as not to distract the driver of the ambulance.

The gas cylinder monitoring system 10 operates as follows:
1. The cylinder monitoring transmitter 16 associated with the gas cylinder 12 broadcasts the advertisement package (AP) at a regular pre-programmed frequency or automatically if the gas level reaches a pre-determined threshold.
2. The advertisement package (AP) is received by the vehicle hub 60.
3. If the data in the advertisement package (AP) indicates the gas content is below a pre-determined threshold, then the alarm 30 on the vehicle hub 60 is activated.
4. The advertisement package (AP) is automatically transmitted by the vehicle hub transmitter 22. In an alternative embodiment, instead of automatic transmission, the advertisement package (AP) can be initiated by the pressing of a button (not shown) by the ambulance personnel. The vehicle hub can also be configured to only send selections of data from the advertisement package (AP) rather than the entire contents.
5. The advertisement package (AP) is received by the hospital hub 70.
6. If the data in the advertisement package (AP) indicates the gas content is below a pre-determined threshold, then the alarm 32 at the hospital 80 is activated to indicate and alert hospital personnel that the cylinder 12 requires replacing.
7. The data received by the base hub 70 is processed by the processor 90 to identify which ambulance 50 contains the empty gas cylinder 12.
8. Hospital or vehicle personnel replace the empty gas cylinder with a new gas cylinder 21 and the alarms 30,32 are reset either automatically or manually.
9. Optionally, if the ambulance 50 attempts to leave the hospital 80 with an empty cylinder then the alarms will not be deactivated so as to alert the ambulance personnel that a cylinder requires replacing.

The above embodiment describes a monitoring system where data indicating the level of gas in the gas cylinder is broadcast from the gas cylinder monitoring transmitter to the vehicle hub in the ambulance, and then from the vehicle hub to the hospital hub at the hospital. This has the advantage that the battery powered gas cylinder monitoring transmitter is only required to send data over short distances, and therefore consumes less power. It will also be understood that sending data over short distances is a particular benefit of using Bluetooth wireless technology. In an alternative embodiment, data from the gas cylinder can be sent or broadcast directly to the hospital hub, thus avoiding the vehicle hub altogether. Alternatively, data from the gas cylinder can be sent to both the vehicle hub and the hospital hub. It will be appreciated that for longer distance data transmission, i.e. from the ambulance to the hospital, Bluetooth data transmission may not be appropriate, instead the use of a mobile Wi-Fi technology can be used.

It will also be appreciated that when the ambulance returns to the hospital, the distance between the cylinder transmitter and the hospital hub may be sufficiently short to allow Bluetooth data transmission, in fact, the use of Bluetooth data transmission between the cylinder transmitter and the hospital hub can be usefully employed such that the hospital hub will only receive data broadcast from the cylinder when the vehicle hub and the hospital hub are sufficiently close, specifically when the ambulance returns to the hospital. This has the advantage that the hospital hub is alerted to a gas cylinder requiring replacement only when the ambulance is at the hospital, thereby preventing receiving data at the hospital hub when the ambulance is not present and gas cylinder replacement is not possible.

It will be appreciated that the gas cylinder monitoring system of the present invention can operate in several ways, either direct transmission of data from the gas cylinder transmitter to the hospital, transmission via the vehicle hub, or transmission to the vehicle hub only with either automatic or optional manual sending on of the data to the hospital hub.

The timing and frequency of the data transmission can also be pre-programmed into the individual gas cylinder monitoring system (and updatable by sending new instructions from the hospital hub if required), triggered by low gas level content, location (via GPS) or via Bluetooth data transmission when the ambulance and hospital are sufficiently close to allow such Bluetooth transmission, or combinations of these triggers.

The broadcasting of the data in an advertisement package (AP) as described above between the cylinder transmitter and the base hub, either directly, or via the vehicle hub, is achieved without the need for pairing or connecting as in conventional Bluetooth data transmission. In conventional Bluetooth data transmission between two devices, a first device is said to be in discoverable mode, i.e. it is continuously sending data, and a second device connects to the first device when the two devices are in range of each other. Once the two devices are connected or paired, data can be transmitted between the two. It should be understood that in the embodiments described above, the cylinder transmitter and the base and vehicle hubs transmit and receive data do not become connected or paired. This results in less energy being consumed when compared to devices which connect or pair with each other to enable data transmission. In an alternative embodiment, the cylinder transmitter and the vehicle or base hubs can connect or pair to enable transfer of data therebetween, although it will be appreciated such a transfer consumes more energy.

1. A gas cylinder monitoring system (10) for monitoring the contents of a gas cylinder in an EMS vehicle (50) including a gas cylinder (12) for receiving and distributing gas therein, an individual cylinder monitoring system (14) operable to monitor data associated with the gas cylinder (12) and having a cylinder monitoring transmitter (16) operable to broadcast the data, and at least one receiving station (60,70) having a receiver (18,20) operable to receive the data from the individual cylinder monitoring system (14) and indicate if the contents of the gas cylinder (12) are below a pre-determined threshold and require replacing.

2. A system according to claim 1 in which the receiving station includes a vehicle hub (60) located in the EMS vehicle (50).

3. A system according to claim 1 in which the receiving station includes a base hub (70) located in a base station (80) remote from the EMS vehicle (50) containing replacement gas cylinders (21).

4. A system according to claim 3 in which the vehicle hub (60) includes a vehicle hub transmitter (22) to broadcast the data associated with the gas cylinder (12) to the base hub (70).

5. A system according to claim 3 in which the cylinder monitoring transmitter (16) is operable to broadcast the data associated with the gas cylinder (12) directly to the base hub (70).

6. A system according to claim 5 in which the base hub (70) is operable to receive the data broadcast from the cylinder monitoring system (14) when the cylinder monitoring system (14) is within range of the base hub (70).

7. A system according to claim 1 in which the receiving station (60,70) is operable to activate an audio and/or visual alarm (30,32) if the contents of the gas cylinder (12) are below a pre-determined threshold.

8. A system according to claim 7 in which the receiving station includes a base hub (70) located in a base station (80) remote from the EMS vehicle (50) containing replacement gas cylinders (21), and in which the cylinder monitoring transmitter (16) is operable to broadcast the data associated with the gas cylinder (12) directly to the base hub (70), in which the base hub (70) is operable to receive the data broadcast from the cylinder monitoring system (14) when the cylinder monitoring system (14) is within range of the base hub (70) and in which the EMS vehicle (50) is prevented from leaving the base station (80) if the alarm is activated and the individual cylinder monitoring system (14) is within range of the base hub (70).

9. A system according to claim 1 in which the cylinder monitoring transmitter (16) is a Bluetooth transmitter.

10. A system according to claim 1 in which the vehicle hub transmitter (22) is a Bluetooth transmitter.

11. A system according to claim 1 further comprising a motion sensor (24) operable to detect movement of the individual cylinder monitoring system (14), in which the cylinder monitoring transmitter (16) is operable to broadcast the data dependent on that movement.

12. A system according to claim 11 in which the cylinder monitoring transmitter (16) is operable to broadcast the immediately if movement ceases.

13. A system according to claim 11, wherein the receiving station includes a vehicle hub (60) located in the EMS vehicle (50) and the receiving station (60, 70) is operable to activate an audio and/or visual alarm (30,32) if the contents of the gas cylinder (12) are below a pre-determined threshold, and wherein the vehicle hub (60) is operable to suppress the audio and/or visual alarm if movement is detected.

14. A system according to claim 1 in which the data broadcast by the cylinder monitoring system (14) includes data to identify the gas cylinder (12), the system further comprising a processor (24) operable to determine the EMS vehicle (50) in which the identified gas cylinder (12) is located.

15. A system according to claim 1 in which the individual cylinder monitoring system (14) includes a GPS device to enable tracking of the location of the gas cylinder (12).

16. A system according to claim 1 in which the vehicle hub (60) includes a receiver operable to receive data from the base hub (60).

17. A system according to claim 1 in which the data associated with the gas cylinder (12) comprises at least one of cylinder identification, gas supply time remaining, expiry date, cylinder type, cylinder location, time since filling, and rate of gas usage.

18. A system according to claim 1 in which the gas cylinder contains at least one of medical air, oxygen, helium, heliox, argon, xenon, nitrous oxide, a nitrous oxide/oxygen mixture, nitric oxide, carbon monoxide, carbogen, SF₆ and H₂S.

19. A system according to claim 1 in which the base station is a hospital (80).

20. A system according to claim 1 in which the data associated with the gas cylinder (12) is broadcast in a discrete advertisement package (AP).

21. A system according to claim 20, wherein the receiving station includes a base hub (70) located in a base station (80) remote from the EMS vehicle (50) containing replacement gas cylinders (21), and the base hub (70) is operable to receive the advertisement package broadcast from the vehicle hub (60) and/or the cylinder monitoring transmitter (16) when the base hub (70) is within range of the vehicle hub (60) and/or the cylinder monitoring transmitter (16).

22. A system according to claim 21 in which the vehicle hub (60) and/or the cylinder monitoring transmitter (16) is more than one vehicle hub (60) and/or cylinder monitoring transmitter (16) located in a different EMS vehicle (50), the base hub (70) operable to identify which of the more than one vehicle hub (60) and/or cylinder monitoring transmitter (16) is broadcasting data received by the base hub (70) to identify the EMS vehicle (50) in which the vehicle hub (60) and/or cylinder monitoring transmitter (16) is located.

23. A system according to claim 22 in which the base hub (70) is operable to identify the more than one vehicle hub (60) and/or cylinder monitoring transmitter (16) broadcasting data received by the base hub (70) at the highest signal strength to determine the location of the vehicle hub (60) and/or cylinder monitoring transmitter (16) and therefore the EMS vehicle (50).
